(19) United States
(12) Patent Application Publication
(10) Pub. No.: US 2013/0077511 A1
(43) Pub. Date: Mar. 28, 2013

(54) SYSTEM, APPARATUS, AND METHOD FOR WIRELESS COMMUNICATION

(71) Applicant: Kazuyuki OZAKI, Yokohama (JP)

(72) Inventor: Kazuyuki OZAKI, Yokohama (JP)

(73) Assignee: Fujitsu Limited, Kawasaki-shi (JP)

(21) Appl. No.: 13/610,812

(22) Filed: Sep. 11, 2012

(30) Foreign Application Priority Data
Sep. 28, 2011 (JP) 2011-212228

(51) Int. Cl. H04W 24/00

(52) U.S. Cl. 370/252

(57) ABSTRACT

A wireless communication system is provided with a wireless transmission apparatus and a wireless reception apparatus. The wireless transmission apparatus includes a plurality of transmission antennas and a transmission unit. The transmission unit performs signal transmission according to a notified operation mode. The wireless reception apparatus includes a plurality of antennas, a reception unit, a reception quality controller, and an operation mode controller. The reception unit performs reception processing of reception signals received by the reception antennas. The reception quality controller measures a reception quality of each reception signal to calculate a ratio of the reception quality. The operation mode controller determines selection or non-selection of an operation mode according to a comparison result of the ratio and a threshold value and gives notification of the selected operation mode.

### CROSS-REFERENCE TO RELATED APPLICATION

This application is based upon and claims the benefit of priority of the prior Japanese Patent Application No. 2011-212228, filed on Sep. 28, 2011, the entire contents of which are incorporated herein by reference.

### FIELD

The embodiments discussed herein relate to a wireless communication system, a wireless communication apparatus and a wireless communication method for performing wireless communication.

### BACKGROUND

Recently, a MIMO (Multi Input Multi Output) system using a plurality of transmission and reception antennas is used for various types of digital communication and employed in IEEE 802.16e, LTE (Long Term Evolution), and the like. The MIMO system is a technique which improves a throughput characteristic by performing signal transmission and reception using a plurality of antennas.

The MIMO system includes two broadly-divided operation modes; a space division multiplexing mode and a transmission diversity mode.

The space division multiplexing mode, on a transmission side, transmits signals of different kinds of information from respective plural different antennas using the same carrier wave frequency at the same time. On a receiving side, the signals are received by a plurality of antennas and demodulated after signal separation has been performed for the received signal in a multiplexing state.

Further, the transmission diversity mode, on the transmission side, transmits signals having the same information from respective plural different transmission antennas at the same time. On the receiving side, the signals received by a plurality of antennas are multiplexed and demodulated.

In the MIMO system, either the space division multiplexing mode or the transmission diversity mode is appropriately selected to perform communication so as to obtain a stable throughput characteristic.

For example, in a wireless transmission apparatus, there is proposed a technique of switching between space division multiplexing and non-space-division multiplexing.

Japanese Laid-Open Patent Application No. 2005-318419

There is a case that imbalance is caused among transmission signal powers from a plurality of transmission antennas in the wireless communication using the MIMO system. In such a communication state, as the operation mode, the transmission diversity mode, in which the reception signals are multiplexed and subjected to reception processing, improves the throughput characteristic more than the space division multiplexing mode.

In a conventional MIMO system, however, the operation mode is selected without control for appropriately recognizing transmission signal power states of the plurality of transmission antennas. Accordingly, there is a case that the space division multiplexing mode is selected even in a situation where the transmission diversity mode provides a higher throughput characteristic.

When the communication is not performed in an appropriate operation mode, a gap is caused between propagation characteristics in an actual communication environment and propagation characteristics of the selected operation mode, and there is caused degradation of the throughput characteristic.

### SUMMARY

According to one aspect of the present embodiment, there is provided a wireless communication system. This wireless communication system includes a wireless transmission apparatus which has a plurality of transmission antennas, and a transmission unit configured to perform signal transmission according to a notified transmission mode, and a wireless reception apparatus which has a plurality of reception antennas, a reception quality controller configured to measure a reception quality of each reception signal and to calculate a ratio of the reception quality, and an operation mode controller configured to determine selection or non-selection of an operation mode and to give notification of the selected operation mode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a wireless communication system;

FIG. 2 explains a space division multiplexing mode;

FIG. 3 explains a transmission diversity mode;

FIG. 4 illustrates a configuration example of a wireless transmission apparatus;

FIG. 5 illustrates a configuration example of a wireless reception apparatus;

FIG. 6 illustrates a table which registers an attribute in a transmission diversity mode;

FIG. 7 illustrates a table which registers an attribute in a space division multiplexing mode;

FIG. 8 illustrates an operation flow;

FIG. 9 illustrates an operation flow; and

FIG. 10 illustrates a weighting coefficient table.

### DESCRIPTION OF EMBODIMENTS

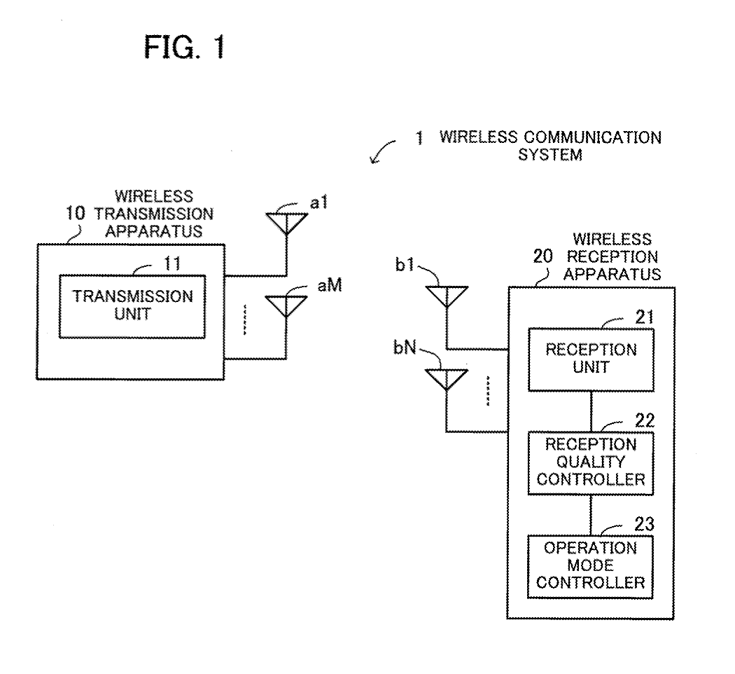

Several embodiments will be described below with reference to the accompanying drawings, wherein like reference numerals refer to like elements throughout. FIG. 1 illustrates a configuration example of a wireless communication system. The wireless communication system 1 includes a wireless transmission apparatus 10 and a wireless reception apparatus 20.

The wireless transmission apparatus 10 includes a plurality of transmission antennas a1 to aM and a transmission unit 11. The transmission unit 11 performs signal transmission according to a notified operation mode. The function of the transmission unit 11 is performed by a processor executing a program stored in a memory, for example.

The wireless reception apparatus 20 includes a plurality of reception antennas b1 to bN, a reception unit 21, a reception quality controller 22, and an operation mode controller 23. The reception unit 21 performs reception processing of reception signals received by the reception antennas b1 to bN. The reception quality controller 22 measures a reception quality of each reception signal to calculate a ratio of a measurement value of the reception quality. Each of the functions of the reception unit 21, the reception quality controller 22, and the operation mode controller 23 is performed by a processor executing a program stored in a memory, for example.

The operation mode controller 23 determines selection or non-selection of an operation mode to be operated according to a comparison result of the calculated ratio and a preliminarily set threshold value. Then, the operation mode controller 23 notifies the wireless transmission apparatus 10 of the selected operation mode.

In this manner, on the side of the wireless reception apparatus 20, the wireless communication system 1 is configured to calculate a ratio of the reception quality in the reception signal for each of the reception antennas b1 to bN and to determine selection or non-selection of the operation mode to be operated according to the comparison result of the ratio and the threshold value.

By obtaining a ratio of the reception quality and performing the comparison processing of the ratio and the threshold value, it is possible to appropriately recognize transmission power states of the transmission antennas a1 to aM. Further, the determination on selection or non-selection (determination on whether appropriate or inappropriate) for the operation mode enables not to select an inappropriate operation mode.

For example, it is assumed that imbalance is recognized to be caused among the transmission powers from the transmission antennas a1 to aM, from the comparison result of the above control. In this case, it becomes possible not to select such an inappropriate operation mode as to degrade the throughput characteristic when the imbalance is caused among the transmission powers (e.g., space division multiplexing mode).

In this manner, the determination processing is performed precisely not to select an operation mode which does not meet propagation characteristics in an actual communication environment but to select an operation mode which meets the propagation characteristics in the actual communication environment, thereby enabling the degradation of the throughput characteristic to be suppressed.

Next, the space division multiplexing mode and the transmission diversity mode will be explained as MINO operation modes. Note that explanation will be made for a case in which the two transmission antennas and the two reception antennas are provided.

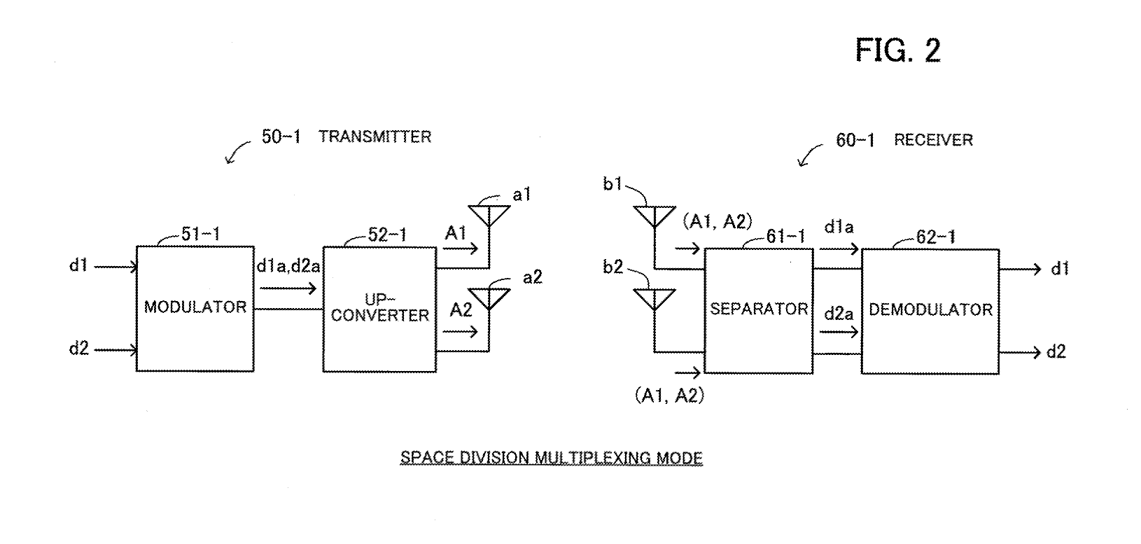

FIG. 2 explains the space division multiplexing mode. A transmitter 50-1 includes a modulator 51-1, an up-converter 52-1, and transmission antennas a1 and a2. A receiver 60-1 includes reception antennas b1 and b2, a separator 61-1, and a demodulator 62-1.

In the transmitter 50-1, the modulator 51-1 generates a modulation signal by modulating data to be transmitted on a carrier wave. In this case, it is assumed that there are different data sets d1 and d2, and the data d1 is modulated to generate a modulation signal d1a and the date d2 is modulated to generate a modulation signal d2a.

The up-converter 52-1 up-converts the modulation signal d1a with a carrier wave frequency to generate a wireless frequency signal A1 and up-converts the modulation signal d2a with the same carrier wave frequency to generate a wireless frequency signal A2. The wireless frequency signal A1 is transmitted from the transmission antenna a1, and the wireless frequency signal A2 is transmitted from the transmission antenna a2.

In the receiver 60-1, the reception antenna b1 receives a wireless frequency signal (A1 and A2) in which the wireless frequency signals A1 and A2 are multiplexed. The reception antenna b2 receives the wireless frequency signal (A1 and A2) in which the wireless frequency signals A1 and A2 are multiplexed.

The separator 61-1 performs down-conversion including separation processing of the wireless frequency signal (A1 and A2), to output the modulation signals d1a and d2a. The demodulator 62-1 demodulates the modulation signals d1a and d2a to reproduce the data sets d1 and d2.

In this manner, on the transmission side, the space division multiplexing mode transmits different signals from the respective transmission antennas using the same carrier wave frequency at the same time. Further, on the reception side, the transmitted signals are received in a multiplexed state and demodulated after the separation.

Note that representative examples of an algorithm of separating the signal are MMSE (Minimum Mean Square Error), MLD (Maximum Likelihood Detection), and the like.

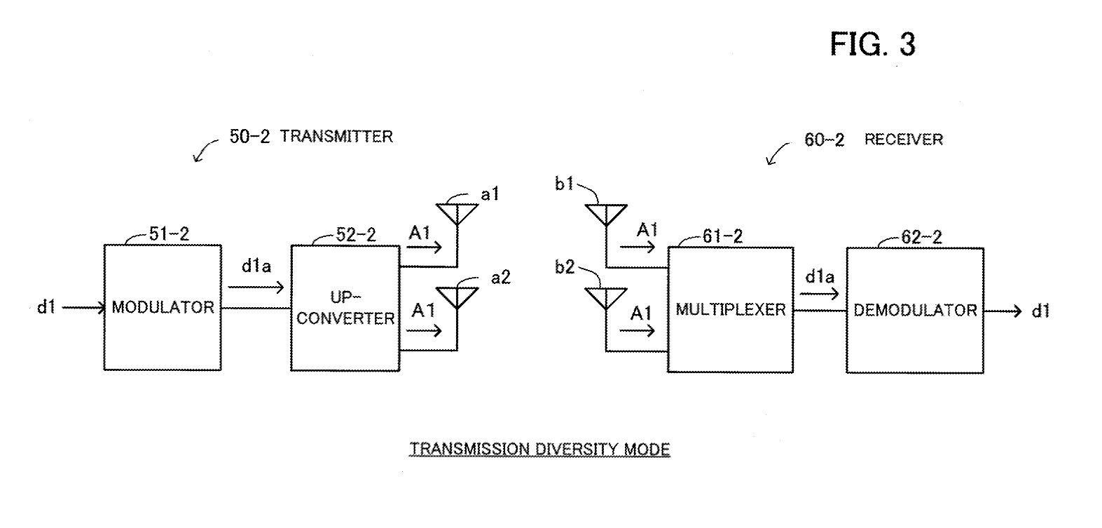

FIG. 3 explains the transmission diversity mode. A transmitter 50-2 includes a modulator 51-2, an up-converter 52-2 and transmission antennas a1 and a2. A receiver 60-2 includes reception antennas b1 and b2, a multiplexer 61-2, and a demodulator 62-2.

In the transmitter 50-2, the modulator 51-2 modulates data d1 to be transmitted on a carrier wave to generate a modulation signal d1a. The up-converter 52-2 performs up-converts the modulation signal d1a with a carrier wave frequency to generate a wireless frequency signal A1. The wireless frequency signal A1 is transmitted from the transmission antennas a1 and a2.

In the receiver 60-2, the reception antennas b1 and b2 receive the wireless frequency signal A1, respectively. The multiplexer 61-2 performs down conversion including multiplexing processing of the wireless frequency signals A1 received by the respective reception antennas b1 and b2, and outputs the modulation signal d1a. The demodulator 62-2 demodulates the modulation signal d1a to reproduce the data d1.

In this manner, on the transmission side, the transmission diversity mode transmits the signal of the same information from the plurality of different transmission antennas at the same time. Further, on the reception side, the transmission signals received by the respective plural antennas are demodulated after the multiplexing to obtain a diversity effect.

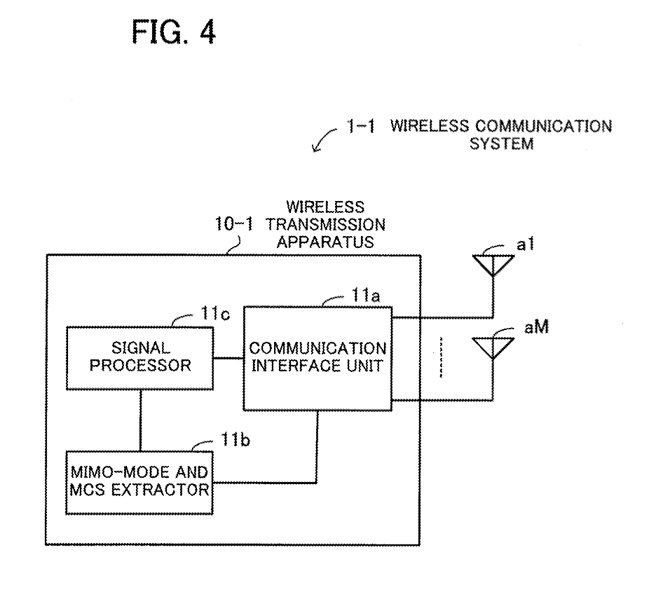

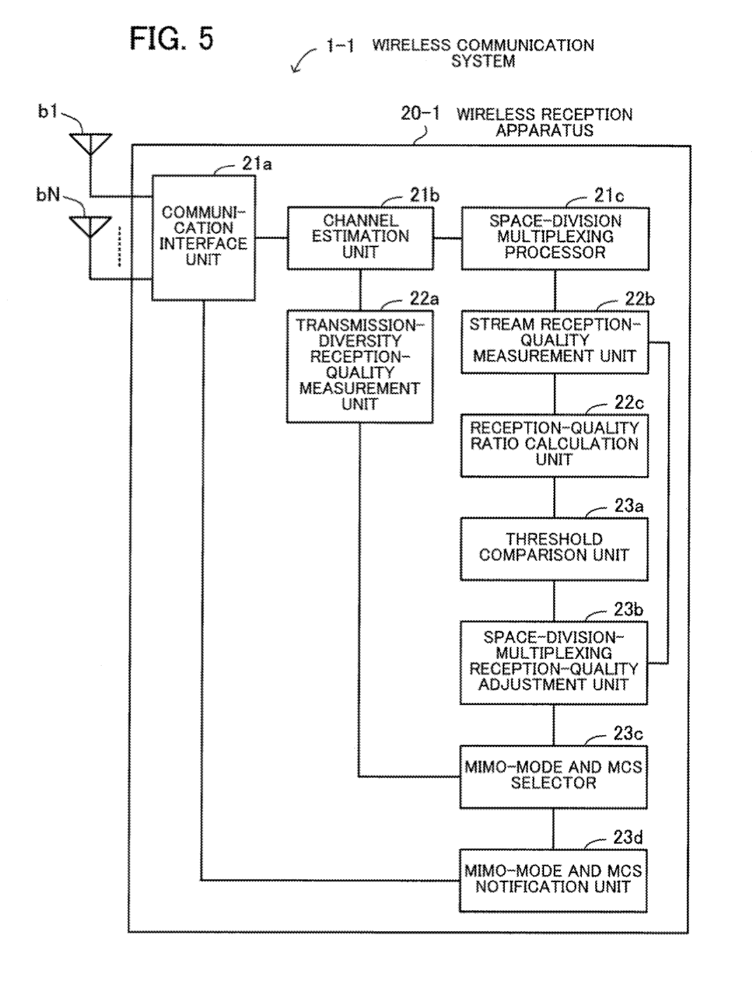

Next, a detailed configuration of the wireless communication system 1 will be explained. FIG. 4 illustrates a configuration example of a wireless transmission apparatus, and FIG. 5 illustrates a configuration example of a wireless reception apparatus.

A wireless communication system 1-1 includes a wireless transmission apparatus 10-1 and a wireless reception apparatus 20-1. Note that, while actually one wireless communication apparatus includes both functions of the wireless transmission apparatus and the wireless reception apparatus, the transmission and reception functions are described separately for easy understanding.

The wireless transmission apparatus 10-1 includes antennas a1 to aM, a communication interface unit 11a, a MIMO-mode and MCS (Modulation and Coding Scheme: combination of a modulation scheme and a coding rate) extractor 11b, and a signal processor 11c. Note that each function of the communication interface unit 11a, the MIMO-mode and MCS extractor 11b, and the signal processor 11c is included in the transmission unit 11 of FIG. 1.

The wireless reception apparatus 20-1 includes antennas b1 to bN, a communication interface unit 21a, a channel estimation unit 21b, a space-division multiplexing processor 21c, a transmission-diversity reception-quality measurement unit 22a, a stream reception-quality measurement unit 22b, a reception-quality ratio calculation unit 22c, a threshold comparison unit 23a, a space-division-multiplexing reception-quality adjustment unit 23b, a MIMO-mode and MCS selector 23c, and a MIMO-mode and MCS notification unit 23d.

Note that each function of the communication interface unit 21a, the channel estimation unit 21b, and the space-division multiplexing processor 21c is included in the reception unit 21 of FIG. 1. Further, each function of the transmission-diversity reception-quality measurement unit 22a, the stream reception-quality measurement unit 22b, and the reception-quality ratio calculation unit 22c is included in the reception quality controller 22 of FIG. 1.

Moreover, each function of the threshold comparison unit 23a, the space-division-multiplexing reception-quality adjustment unit 23b, the MIMO-mode and MCS selector 23c, and the MIMO mode and MCS notification unit 23d is included in the operation mode controller 23 of FIG. 1.

In the wireless reception apparatus 20-1, the communication interface unit 21a converts signals received by the reception antennas b1 to bN into baseband signals for reception processing. Further, the communication interface unit 21a performs analog-to-digital conversion of the baseband signals to convert the baseband signal of analog signal into a digital signal.

The channel estimation unit 21b estimates a channel between transmission and reception from the reception signal. The space-division multiplexing processor 21c performs signal separation of a multiplexed signal in a space division multiplexing mode to generate a stream. The stream means a signal after the multiplexed signal in the space division multiplexing mode has been separated.

The transmission-diversity reception-quality measurement unit 22a measures a reception quality of the transmission diversity mode (contents of the reception quality measurement in the transmission diversity mode will be described below). The stream reception-quality measurement unit 22b measures the reception quality of each stream after the multiplexed signals received by antennas b1 to bN have been subjected to separation processing in the space-division multiplexing processor 21c (contents of the reception quality measurement of the stream in the space division multiplexing mode will be described below).

The reception-quality ratio calculation unit 22c calculates a ratio of the reception quality of each stream in the space division multiplexing mode. The threshold comparison unit 23a compares the reception quality ratio and a preliminarily set threshold value.

The space-division-multiplexing reception-quality adjustment unit 23b adjusts a reception quality value of the space division multiplexing mode using the stream reception quality measured in the stream reception-quality measurement unit 22b and the result of the threshold value comparison in the threshold comparison unit 23a.

The MIMO-mode and MCS selector 23c selects a MIMO mode and MCS as the operation modes using the reception quality of the transmission diversity mode measured in the transmission-diversity reception-quality measurement unit 22a and the reception quality of the space division multiplexing mode adjusted in the space-division-multiplexing reception-quality adjustment unit 23b.

The MIMO-mode and MCS notification unit 23d notifies the transmission side of the selected operation mode. In this case, the selected operation mode is transmitted to the communication interface unit 21a, and the operation mode information is up-converted in the communication interface unit 21a to be transmitted via the antennas b1 to bN.

In the wireless transmission apparatus 10-1, the communication interface unit 11a receives, via the antennas a1 to aM, and down-converts the operation mode information transmitted from the wireless reception apparatus 20-1.

The MIMO-mode and MCS extractor 11b extracts and transfers the operation mode information to the signal processor 11c. The signal processor 11c modulates data according to the notified operation mode.

When the MIMO operation mode is the transmission diversity mode, transmission diversity processing is performed and, when the MIMO operation mode is the space division multiplexing mode, the space division multiplexing processing is performed. The communication interface unit 11a converts a baseband signal into a carrier wave frequency band and performs data transmission from the antennas a1 to aM.

Next, the operation will be explained in detail by the use of specific calculation expressions. Note that the number of the transmission or reception antennas is assumed to be N (M=N). Further, it is assumed that the MMSE weighting is used for the signal separation in the space division multiplexing mode and CINR (Carrier to Interference and Noise Ratio) is measured as the reception quality.

The channel estimation unit 21b estimates a channel between transmission and reception using a known sequence and the signal after the analog-to-digital conversion in the communication interface unit 21a. An estimated channel matrix is expressed by following expression (1).

$$\begin{matrix}H = [ {H}_{0} , … {H}_{M - 1} ] \\ = [ \begin{matrix}{H}_{0 , 0} & … & {H}_{0 , M - 1} \\ ⋮ & ⋱ & ⋮ \\ {H}_{N - 1 , 0} & … & {H}_{N - 1 , M - 1}\end{matrix} ]\end{matrix} \qquad ( 1 )$$

Here, Hₘ=[H_{0, m}, . . . , H_{n-1, m}] ^{T} expresses an (N×1) channel vector of the m-th transmission signal, and H_{n, m} expresses a channel estimation value of the reception antenna n and the transmission antenna m.

The transmission-diversity reception-quality measurement unit 22a measures CINR of the reception signal in the transmission diversity mode. A CINR value of the transmission diversity mode CINR^{div} is calculated by following expression (2). Here, σ² expresses noise power.

$${CINR}^{div} = \frac{{\sum }_{n = 0}^{N - 1} {\sum }_{m = 0}^{M - 1} {\vert {H}_{n , m} \vert}^{2}}{{σ}^{2}} \qquad ( 2 )$$

The MIMO-mode and MCS selector 23c obtains the highest frequency utilization efficiency Ediv satisfying a required quality for transmission in the transmission diversity mode, from the obtained CINR values of the transmission diversity mode.

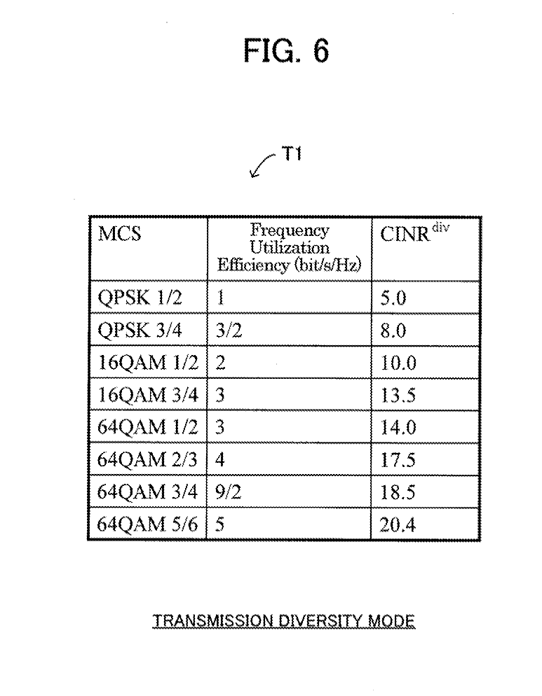

FIG. 6 illustrates a table which registers an attribute in the transmission diversity mode. The MIMO-mode and MCS selector 23c has the table T1. The table T1 registers and retains a relationship among MCS, the frequency utilization efficiency Ediv (bit/s/Hz), and CINR^{div} as the attribute in the transmission diversity mode.

An example of how to view the table T1 is as follows; when CINR^{div} of the transmission diversity mode is, for example, not less than 5.0 and less than 8.0, the frequency utilization efficiency is represented as Ediv=1 and MCS of QPSK (Quadrature Phase Shift Keying: R=½) is selected.

That is, when the frequency utilization efficiency Ediv=1, the transmission diversity mode and QPSK (R=½) are selected for MIMO and MCS as the operation modes, respectively.

Further, when CINR^{div} of the transmission diversity mode is not less than 10.0 and less than 13.5, the frequency utilization efficiency is represented as Ediv=2, and 16QAM (Quadrature Amplitude Modulation: R=½) is selected for MCS.

That is, when the frequency utilization efficiency Ediv=2, the transmission diversity mode and 16QAM (R=½) are selected for MIMO and MCS as the operation modes, respectively.

On the other side, the space-division multiplexing processor 21c generates a weighting matrix W for the signal separation in the space division multiplexing mode. The weighting matrix W is expressed by following expression (3). Here, Wₘ expresses a (1×N) MMSE weighting vector for the m-th transmission signal.

$$\begin{matrix}W = [ \begin{matrix}{W}_{0} \\ ⋮ \\ {W}_{M - 1}\end{matrix} ] \\ = [ \begin{matrix}{W}_{0 , 0} & … & {W}_{0 , N - 1} \\ ⋮ & ⋱ & ⋮ \\ {W}_{M - 1 , 0} & … & {W}_{M - 1 , N - 1}\end{matrix} ]\end{matrix} \qquad ( 3 )$$

The stream reception-quality measurement unit 22b measures a CINR value of each stream in the space division multiplexing mode. A CINR value CINR(m)^{sdm} of the m-th stream is calculated by following expression (4) (while the left side of expression (4) attaches “sdm” and “m” for an upper suffix and a lower suffix of CINR, respectively, the expression of “CINR(m)^{sdm}” is also used in the description).

$${CINR}_{m}^{sdm} = \frac{{W}_{m} {H}_{m}}{1 - {W}_{m} {H}_{m}} \qquad ( 4 )$$

Since above expression (4) expresses the reception quality for each stream, the reception quality of the space division multiplexing mode is represented by an average value, a minimum value, a maximum value, and the like of the CINR values for the respective signals expressed by expression (4). When the average value is assumed to be used in this example, the average value is calculated by following expression (5).

$${CINR}^{sdm} = \frac{1}{M} {\sum }_{m = 0}^{M - 1} {CINR}_{m}^{sdm} \qquad ( 5 )$$

The reception-quality ratio calculation unit 22c calculates a CINR value ratio of each stream. At this time, for a stream having the maximum CINR value, a ratio of a CINR value for each of other streams to the maximum CINR value is measured.

A CINR ratio Ratioᵢⱼ of the i-th stream to the j-th stream is calculated by expression (6) (in the expression, CINR^{sdm} of the j-th stream corresponds to the maximum CINR value).

$${Ratio}_{ij} = 10 \vert {log}_{10} \frac{{CINR}_{i}^{sdm}}{{CINR}_{j}^{sdm}} \vert \qquad ( 6 )$$

The space-division-multiplexing reception-quality adjustment unit 23b adjusts the CINR value of the space division multiplexing mode according to the CINR ratio obtained by expression (6).

Here, when the ratio obtained by expression (6) is higher than a set threshold value, it is recognized that imbalance is caused among the transmission signal powers from the transmission side antennas a1 to aM. Note that the imbalance is caused, for example, in a case where the transmission signal from one transmission antenna is blocked by a shielding material and the transmission signals from the other antennas are not blocked by the shielding material.

Accordingly, for the reception quality adjustment method in this case, the CINR value is multiplied by zero (coefficient 0) so that the space division multiplexing mode, which degrades the throughput characteristic when the imbalance is caused among the transmission powers, is not selected.

Further, when the ratio obtained by expression (6) is less than the set threshold value, it is recognized that the transmission signal powers from the transmission antennas a1 to aM are approximately balanced. In this case, the space division multiplexing mode is a candidate for the operation mode to be selected, and, for the adjustment method of the reception quality, the averaged CINR value of the streams is set to be a CINR value for the space division multiplexing mode.

The MIMO-mode and MCS selector 23c obtains the highest frequency utilization efficiency Esdm satisfying a required quality for transmission in the space division multiplexing mode, from the CINR value (average value) of the space division multiplexing mode.

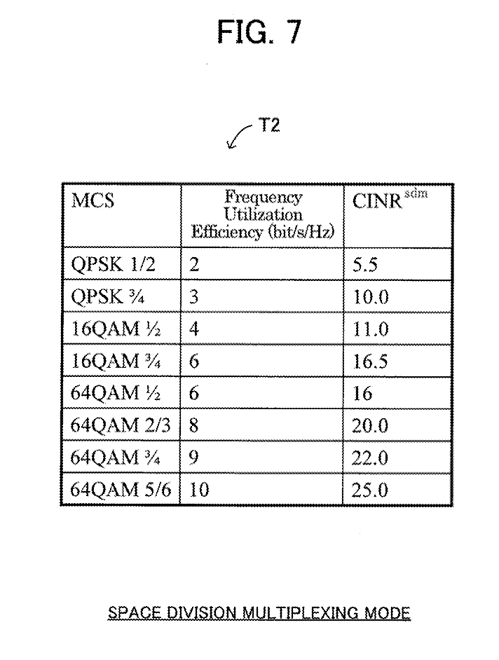

FIG. 7 illustrates a table which registers an attribute in the space division multiplexing mode. The MIMO-mode and MCS selector 23c has the table T2. The table T2 registers and retains a relationship among MCS, the frequency utilization efficiency Esdm (bit/s/Hz), and CINR^{sdm} as the attribute in the space division multiplexing mode.

An example of how to view the Table T2 is as follows; when CINR^{sdm} of the space division multiplexing mode is not less than 5.5 and less than 10.0, the frequency utilization efficiency is represented as Esdm=2, and QPSK (R=½) is selected for MCS.

That is, when the frequency utilization efficiency is represented as Esdm=2, the space division multiplexing mode and QPSK (R=½) are selected for MIMO and MCS as the operation modes, respectively.

Further, when CINR^{sdm} of the space division multiplexing mode is not less than 11.0 and less than 16.5, the frequency utilization efficiency is represented as Esdm=4, and 16QAM (R=½) is selected for MCS.

That is, when the frequency utilization efficiency is represented as Esdm=4, the space division multiplexing mode and 16QAM (R=½) are selected for MIMO and MCS as the operation modes, respectively.

The MIMO-mode and MCS selector 23c compares the frequency utilization efficiency Ediv of the transmission diversity mode and the frequency utilization efficiency Esdm of the space division multiplexing mode. Then, the operation mode having a higher frequency utilization efficiency is obtained from the table T1 or the table T2 and the MIMO-mode and MCS are determined. The MIMO-mode and MCS notification unit 23d notifies the transmission side of the selected MIMO-mode and MCS.

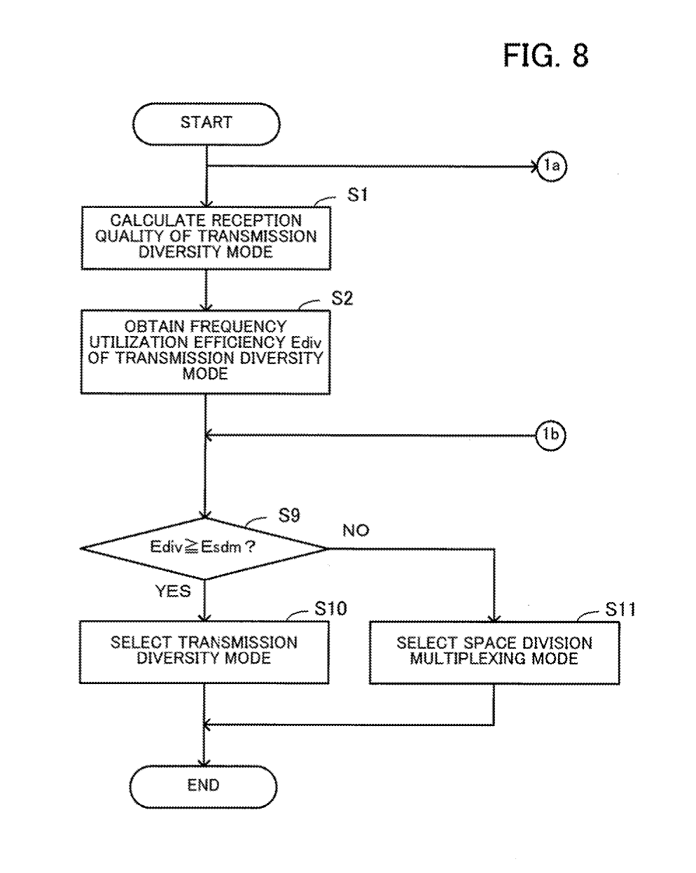

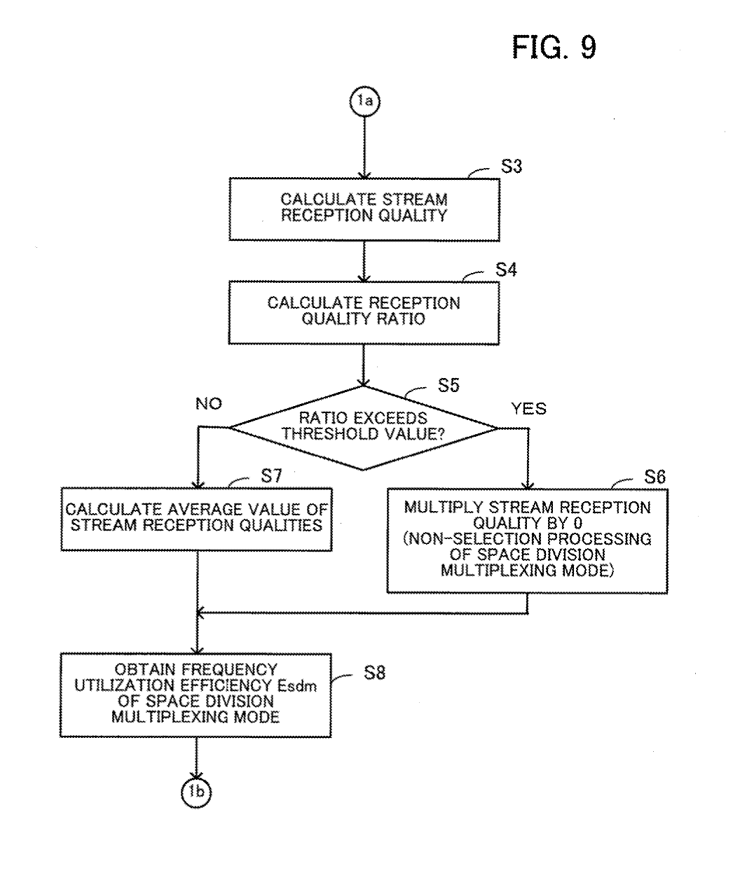

Next, explanation will be provided using a flowchart. FIG. 8 and FIG. 9 illustrate an operation flow.

[S1] The transmission-diversity reception-quality measurement unit 22a calculates CINR^{div} of the transmission diversity mode using expression (2).

[S2] The MIMO-mode and MCS selector 23c obtains the highest frequency utilization efficiency Ediv satisfying the required quality for transmission in the transmission diversity mode from CINR^{div} of the transmission diversity mode.

[S3] The stream reception-quality measurement unit 22b calculates CINR(m)^{sdm} of the m-th stream using expression (4).

[S4] The reception-quality ratio calculation unit 22c calculates the CINR ratio of the stream using expression (6).

[S5] The threshold comparison unit 23a compares the CINR ratio and the threshold value. When the CINR ratio exceeds the threshold value, the process goes to step S6, and, when the CINR ratio does not exceed the threshold value, the process goes to step S7.

[S6] The space-division-multiplexing reception-quality adjustment unit 23b multiplies CINR of each stream by zero.

[S7] The space-division-multiplexing reception-quality adjustment unit 23b calculates the CINR average value of the plurality of streams using expression (5).

[S8] The MIMO-mode and MCS selector 23c obtains the highest frequency utilization efficiency Esdm satisfying the required quality for transmission in the space division multiplexing mode from CINR^{sdm} (average value) of the space division multiplexing mode.

[S9] The MIMO-mode and MCS selector 23c compares the frequency utilization efficiencies Ediv and Esdm. When the frequency utilization efficiency Ediv is equal to or higher than the frequency utilization efficiency Esdm, the process goes to step S10, and, when the frequency utilization Ediv is lower than the frequency utilization efficiency Esdm, the process goes to step S11.

[S10] The MIMO-mode and MCS selector 23c selects the transmission diversity mode.

[S11] The MIMO-mode and MCS selector 23c selects the space division multiplexing mode.

As explained above, when the ratio in the stream reception quality of the space division multiplexing mode exceeds the threshold value and the imbalance is recognized to be caused among the transmission signal powers, the space division multiplexing mode is not selected.

Further, when the ratio does not exceed the threshold value, the frequency utilization efficiency Esdm is obtained from the reception quality of the space division multiplexing mode and the frequency utilization efficiency Ediv is obtained from the reception quality of the transmission diversity mode, and the operation mode having a higher frequency utilization efficiency is configured to be selected.

Thereby, when the imbalance is caused among the transmission signal powers, the space division multiplexing mode which degrades the throughput characteristic is not selected but the transmission diversity mode is selected, and it becomes possible to suppress the degradation of the throughput characteristic.

Further, when the imbalance is not caused among the transmission signal powers, one having a higher frequency utilization efficiency is selected out of the space division multiplexing mode and the transmission diversity mode, and thereby an operation mode suitable for a propagation environment is selected and it becomes possible to improve the throughput characteristic.

Next, the operation of determining whether to select the space division multiplexing mode or not will be explained by the use of specific numerical examples.

First, there will be explained a case in which the space division multiplexing mode remains as a selection candidate and either one of the transmission diversity mode or the space division multiplexing mode is determined (case in which antenna imbalance is 0 dB). Here, the number of the transmission or reception antennas is assumed to be two and it is assumed that SNR (Signal to Noise Power Ratio)=10 dB (10).

The channel matrix estimated by the channel estimation unit 21b is assumed to be expressed by following expression (7).

$$H = [ \begin{matrix}0.4867 + 1.2680 i & - 1.1639 + 0.3838 i \\ 0.8198 - 0.1264 i & - 0.5878 - 0.1897 i\end{matrix} ] \qquad ( 7 )$$

Further, the MMSE weighting matrix W generated by the space-division multiplexing processor 21c is assumed to be expressed by following expression (8).

$$\begin{matrix}W = {{H}^{H} ( {HH}^{H} + 1 / SNRI )}^{- 1} \\ = [ \begin{matrix}- 0.0731 - 0.3659 i & 0.5493 + 0.4149 i \\ - 0.3423 - 0.3455 i & - 0.4472 + 0.6049 i\end{matrix} ]\end{matrix} \qquad ( 8 )$$

The stream reception-quality measurement unit 22b calculates the CINR value of the m-th stream CINR (m)^{sdm} by above expression (4). Here, W·H in expression (4) is given by following expression (9).

$$WH = [ \begin{matrix}0.9311 & - 0.0187 + 0.0498 i \\ - 0.0187 - 0.0498 i & 0.9086\end{matrix} ] \qquad ( 9 )$$

The transmission-diversity reception-quality measurement unit 22a calculates CINR^{div} of the reception signal in the transmission diversity mode using expression (2). CINR^{div} of the transmission diversity mode is calculated as CINR^{div}=44.1646.

The MIMO-mode and MCS selector 23c obtains the highest frequency utilization efficiency Ediv satisfying CINR^{div}=44.1646, from the table T1 of FIG. 6. The highest frequency utilization efficiency is obtained from the table T1 as Ediv=5.

On the other side, the stream reception-quality measurement unit 22b measures the 0-th and first stream reception qualities CINR(0) and CINR(1)^{sdm} using expression (4). According to expression (4) and expression (9), the reception qualities are calculated as CINR(0)^{sdm}=13.5199 and CINR(1)^{sdm}=9.9389.

The reception-quality ratio calculation unit 22c calculates the reception quality ratio Ratio₀₁ using expression (6). The reception quality ratio is calculated as Ratio₀₁=1.3364.

The threshold comparison unit 23a assumes that the preliminarily set threshold value is 15 and compares the calculated ratio Ratio₀₁ and the threshold value. As (Ratio₀₁=1.3364)≦(Threshold value=15), the ratio is lower than the threshold value. Accordingly, it is recognized that the transmission signal powers are balanced.

The space-division-multiplexing reception-quality adjustment unit 23b uses the averaged CINR value of the stream as the CINR value of the space division multiplexing mode CINR^{sdm}. In this example, the CINR value of the space division multiplexing mode is calculated from expression (5) as CINR^{sdm}=(CINR(0)^{sdm}+CINR(1)^{sdm})/2=11.7294.

The MIMO-mode and MCS selector 23c obtains the highest frequency utilization efficiency Esdm satisfying CINR^{sdm}=11.7294 from the table T2 of FIG. 7. The highest frequency utilization efficiency is obtained from the table T2 as Esdm=4.

The MIMO-mode and MCS selector 23c compares the frequency utilization efficiencies Ediv and Esdm. The comparison result is obtained as Ediv (=5)>Esdm (=4), and the transmission diversity mode is selected.

That is, the MIMO-mode and MCS selector 23c selects the transmission diversity mode as the operation mode of MIMO and selects 64QAM (R=5/6) as the operation mode of MCS from the table T1.

The MIMO-mode and MCS notification unit 23d notifies the transmission side of the selected operation modes and the transmission side performs data transmission using the notified operation modes (transmission diversity mode and 64QAM (R=5/6)).

Next, there will be explained a case in which the space division multiplexing mode is not selected (case in which the antenna imbalance is 20 dB, for example). Here, the number of the transmission or reception antennas is assumed to be two and it is assumed that SNR=10 dB (10).

The channel matrix estimated by the channel estimation unit 21b is assumed to be expressed by following expression (10).

$$H = [ \begin{matrix}- 0.4438 - 3.4978 i & - 0.2551 + 0.0649 i \\ - 0.0681 + 0.3668 i & - 0.0396 - 0.0196 i\end{matrix} ] \qquad ( 10 )$$

Further, the MMSE weighting matrix W generated by the space-division multiplexing processor 21c is assumed to be expressed by following expression (11).

$$\begin{matrix}W = {{H}^{H} ( {HH}^{H} + 1 / SNRI )}^{- 1} \\ = [ \begin{matrix}- 0.0355 + 0.2697 i & - 0.0255 - 0.0721 i \\ - 0.0887 - 0.0051 i & - 0.6301 + 0.1998 i\end{matrix} ]\end{matrix} \qquad ( 11 )$$

The stream reception-quality measurement unit 22b calculates the m-th stream CINR value CINR(m)^{sdm} by above expression (4). Here, W·H in expression (4) is given by following expression (12).

$$\begin{matrix}W \\ H\end{matrix} = [ \begin{matrix}0.9872 & - 0.0089 - 0.0677 i \\ - 0.0089 + 0.0677 i & 0.0518\end{matrix} ] \qquad ( 12 )$$

The transmission-diversity reception-quality measurement unit 22a calculates CINR^{div} of the reception signal in the transmission diversity mode using expression (2). CINR^{div} of the transmission diversity mode is calculated as CINR^{div}=126.4218.

The MIMO-mode and MCS selector 23c obtains the highest frequency utilization efficiency Ediv satisfying CINR^{div}=126.4218 from the table T1 of FIG. 6. The maximum frequency utilization efficiency is obtained from the table T1 as Ediv=5.

On the other side, the stream reception-quality measurement unit 22b measures the 0-th and the first stream reception qualities CINR(0)^{sdm} and CINR(1)^{sdm} using expression (4). According to above expression (12), the stream reception qualities are calculated as CINR(0)^{sdm}=77.0345, and CINR(1)^{sdm}=0.0547.

The reception-quality ratio calculation unit 22c calculates the reception quality ratio Ratio₀₁ using expression (6). The reception quality ratio is calculated as Ratio₀₁=31.4893.

The threshold comparison unit 23a assumes the preliminarily set threshold value to be 15, and compares the calculated ratio Ratio₀₁ and the threshold value. As (Ratio Ratio₀₁=31.4893>(Threshold value=15), the ratio is higher than the threshold value. Accordingly, it is recognized that the transmission signal powers are imbalanced.

The space-division-multiplexing reception-quality adjustment unit 23b multiplies the CINR value of the stream by zero and sets the CINR value of the space division multiplexing mode as CINR^{sdm}=0. That is, the space-division-multiplexing reception-quality adjustment unit 23b recognizes that the imbalance is caused among the transmission signal powers from the transmission side antennas a1 to aM, and sets CINR^{sdm} of the space division multiplexing mode to zero by multiplying the CINR value of each stream by zero, so as not to select the space division multiplexing mode.

The MIMO-mode and MCS selector 23c obtains the highest frequency utilization efficiency satisfying CINR^{sdm}=0 from the table T2 of FIG. 7. The highest frequency utilization efficiency is obtained from the table T2 as Esdm=0.

The MIMO-mode and MCS selector 23c compares the frequency utilization efficiencies Ediv and Esdm. The comparison result is obtained as Ediv (=5)>Esdm (=0), and the transmission diversity mode is selected (the space division multiplexing mode is forced not to be selected and the transmission diversity mode is selected).

That is, the MIMO-mode and MCS selector 23c selects the transmission diversity mode as the MIMO operation mode and selects 64QAM (R=5/6) as the MCS operation mode from the table T1.

The MIMO-mode and MCS notification unit 23d notifies the transmission side of the selected operation modes and the transmission side performs data transmission by the notified operation modes (transmission diversity mode and 64QAM (R=5/6)).

Next, there will be explained a variation example of providing weighting for the reception quality of the space division multiplexing mode. In the above description, when the ratio exceeds the threshold value, CINR of each stream is multiplied by zero and, when the ratio does not exceed the threshold value, a CINR average value is obtained among the streams. In the variation example, when the ratio does not exceed the threshold value, an average value is obtained after CINR of each stream has been multiplied by a coefficient (weighting coefficient) which is not zero.

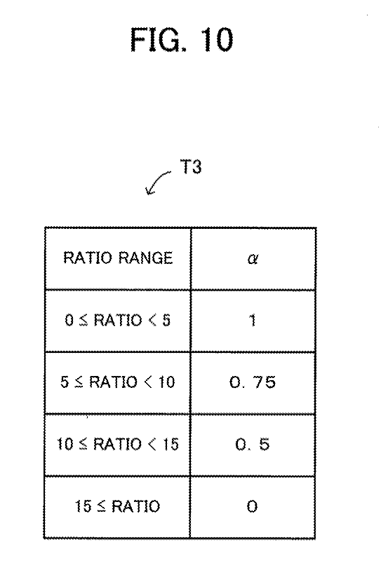

FIG. 10 illustrates a weighting coefficient table. The space-division-multiplexing reception-quality adjustment unit 23b has the weighting coefficient table T3. The weighting coefficient table T3 registers and retains an attribute of a ratio range and a weighting coefficient (0).

The example of FIG. 10 represents α=1 in a ratio range not less than 0 and less than 5, α=0.75 in a ratio range not less than 5 and less than 10, α=0.5 in a ratio range not less than 10 and less than 15, and α=0 in a ratio range not less than 15 (case of not selecting the space division multiplexing mode).

Here, when CINR of the stream is adjusted by the weighting coefficient, the average value is expressed by following expression (13) for the streams (0) and (1), for example.

CINR^{sdm}=α×(CINR(0)^{sdm}+CINR(1)^{sdm})/2 (13)

In this manner, it becomes possible to obtain the reception quality of the space division multiplexing mode flexibly according to the propagation environment, by providing the weighting for the reception quality of each stream to obtain the reception quality of the space division multiplexing mode.

It becomes possible not to select an inappropriate operation mode.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A wireless communication system, comprising:
a wireless transmission apparatus including a plurality of transmission antennas, and a transmission unit configured to perform signal transmission according to a notified operation mode; and
a wireless reception apparatus including a plurality of antennas, a reception quality controller configured to measure a reception quality of each reception signal and to calculate a ratio of the reception quality, and an operation mode controller configured to determine selection or non-selection of an operation mode according to a comparison result of the ratio and a threshold value, and to give notification of the selected operation mode.

2. The wireless communication system according to claim 1,
wherein the operation mode controller, when the ratio exceeds the threshold value, recognizes that imbalance is caused among transmission signal powers from a plurality of the transmission antennas and determines non-selection of a space division multiplexing mode as the operation mode.

3. The wireless communication system according to claim 1,
wherein the operation mode controller,
in the reception quality measurement of a space division multiplexing mode,
calculates an average value of the reception qualities in each stream and obtains a first frequency utilization efficiency corresponding to the average value, when the ratio does not exceed the threshold value,
in the reception quality measurement of a transmission diversity mode,
calculates a combined value of the reception qualities for each of the reception antennas, and obtains a second frequency utilization efficiency corresponding to the combined value, and
compares the first frequency utilization efficiency and the second frequency utilization efficiency, to select one of the space division multiplexing mode and the transmission diversity mode as an operation mode having a higher frequency utilization efficiency.

4. The wireless communication system according to claim 3,
wherein the operation mode controller performs weighting for the reception quality in each stream in the reception quality measurement of the space division multiplexing mode,
multiplies the reception quality in each stream by zero when the ratio exceeds the threshold value, and
calculates the average value by performing weighting for the reception quality in each stream using a coefficient having a value except zero, when the ratio does not exceed the threshold value.

5. A wireless communication apparatus, comprising:
a plurality of reception antennas;
a reception quality controller configured to measure a reception quality of each reception signal and to calculate a ratio of the reception quality; and
an operation mode controller configured to determine selection or non-selection of an operation mode to be operated according to a comparison result of the ratio and a threshold value and to notify a transmission side of the selected operation mode.

6. A wireless communication method, comprising:
measuring a reception quality of each reception signal received by a plurality of antennas to calculate a ratio of the reception quality;
determining selection or non-selection of an operation mode to be operated according to a comparison result of the ratio and a threshold value; and
notifying a transmission side of the selected operation mode.
